(19) United States
(12) Patent Application Publication
(10) Pub. No.: US 2007/0193116 A1
(43) Pub. Date: Aug. 23, 2007

(54) Fabric roof planter

(75) Inventors: Kelly William Luckett, St. Louis, MO (US); John Victor Jost, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Kelly Luckett

(21) Appl. No.: 11/357,609

(22) Filed: Feb. 17, 2006

(51) Int. Cl. A01G 9/02

(52) U.S. Cl. 47/65.9

(57) ABSTRACT

A roof planter comprising growth media capable of sustaining a desired vegetation, a sack retaining a quantity of the growth media, the sack being formed of moisture permeable material that is capable of retaining the growth media, the sack having an opening capable of accepting the growth media, and a pad in association with the sack and capable of separating the sack from the top of a roof. When the desired vegetation is planted in the growth media being retained by the sack, and the pad is positioned between the sack and the roof, the vegetation may grow in the sack on the roof without causing damage to the roof.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

Green roofs, roof gardens, eco-roofs all refer to the planting of vegetation on the roof surface of building structures. The principle of green roofs has been widely used in Europe for several decades. Roof top vegetation substantially reduces storm water run off, solar heat gain, and thermal transfer through the roof. In addition, large vegetated surfaces help to replenish oxygen through photosynthesis. Though the benefits are many, the typical green roof costs are several times that of most roofing systems. The high price of typical green roof construction emanates from costly waterproofing procedures, extensive drainage layers, soil of depths ranging from eight inches to twenty four inches, and additional required structural construction to support resulting increased weight. Repairs to the roofing membrane are extremely expensive due to the large quantities of material that must be moved to access the waterproofing layer.

Roof planters have recently been developed that can be placed atop standard roofs without the need for special roof construction. These include modular and full system planters in which the plants are housed in rigid containers atop the roof. However, these planters still have cost disadvantages. In particular, the material handling aspect of green roof installation continues to be problematic. Large amounts of soil (also known as “growth media”) are needed for plant growth on rooftops. Transporting the required soil from the source to the project rooftop is difficult and expensive. While pre-planted module planters are a significant improvement over previous methods of green roof installation, they are heavy and the cost of such module planters presents a barrier that many projects are unable to overcome. Moreover, it is desirable that planters installed on a roof be movable in order to provide access to the roof under the planters for inspection and maintenance of the roof. Hence, a more mobile and cost-effective planter is desirable. In addition, there is resistance to using green roof systems due to the need for installation methods that vary substantially from techniques and methods traditionally used in the roofing industry. Hence, it is desirable to have a roof planter that can be installed by more traditional methods commonly used in the roofing industry.

In addition, each roofing manufacturer markets and sells roofing material of differing compositions, and each manufacturer offers warranties on its new roofing material. During construction of a roof, it is often desirable and/or necessary for the laborers to tread upon newly laid roofing. To minimize trauma to the newly laid roofing and to prevent the voiding of warranties on the newly laid roofing, each manufacturer markets and sells walk pad material that can be placed upon the newly laid roofing to allow laborers to walk atop the newly laid roofing with minimal damage and without voiding the roofing manufacturer's warranties. Each roofing manufacturer's walk pad is composed of material specifically engineered for use on that same manufacturer's roofing material. The use of any other walk pad or any other material on the roof risks damage to the roofing material and voiding of the manufacturer's warranty. This can present yet another major obstacle to the acceptability of green roof systems.

### BRIEF DESCRIPTION OF THE SEVERAL VIEWS OF THE DRAWINGS

The illustrative embodiments of the present invention are shown in the following drawings that form a part of the specification:

FIG. 1 is a perspective view of an embodiment of the roof planter of the present invention, the roof planter setting on a pad atop a roof surface;

FIG. 2 is a macro view of the material used to construct an embodiment of the roof planter of the present invention;

FIG. 3 is a perspective view of a portion of the top of an embodiment of the roof planter of the present invention showing a cross-shaped slit having plants rooted in growth media of the planter;

FIG. 4 is a perspective view of a pallet upon which are stacked multiple roof planters having the embodiment of the present invention;

FIG. 5 is a perspective view of the sack of the first embodiment of the roof planter of the present invention, wherein the sack is shown open at one end;

FIG. 6 is a perspective view of multiple roof planters of the present invention stacked atop a pallet;

Corresponding reference characters indicate corresponding parts throughout the several views of the drawings.

### DETAILED DESCRIPTION OF INVENTION

In an illustrative embodiment of the present invention (FIG. 1), the fabric roof planter 10 is shown positioned on a roof upper surface 11. The planter 10 comprises a fiber sack 12, nine slits 14 in the sack 12, growth media 16 retained in the sack 12, and a protective pad 20 positioned between the sack 12 and the roof surface 11. The roof surface 11 comprises a membrane M atop the surface 11. The surface 11 may be of virtually any profile, including for example, flat, pitched, curved or otherwise uneven. The sack 12 is formed of a moisture permeable material, preferably a high durability plastic fiber, and even more preferably knitted high density polyethylene 30 (see FIG. 2), with a weave that is tight enough to retain the growth media 16 in the sack 12 while allowing moisture to pass through the sack 12. This construction also keeps sharp particles from spilling out of the sack 12 onto the roof surface 11 and into roof drainage systems. As shown in FIGS. 1 and 3, the vegetation 18 is planted in the growth media 16 through the slits 14 in the sack 12. The slits 14 may be preformed in the sack 12, prior to filling with the growth media 16, or the slits 14 may be cut into the sack 12 at any time thereafter to accommodate planting the vegetation 18 in the planter 10.

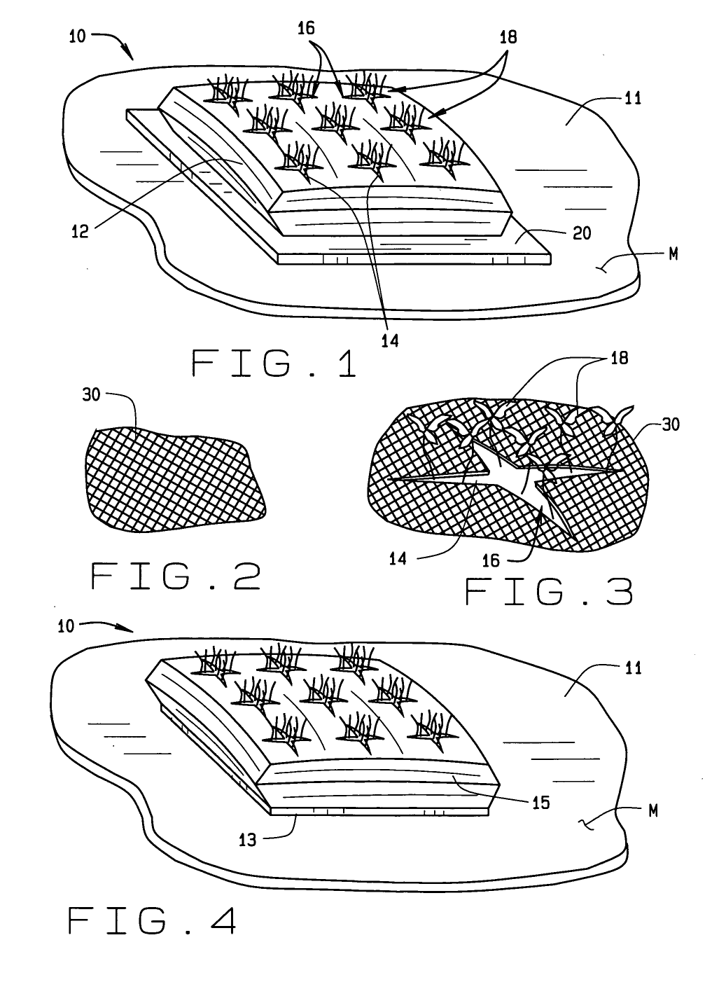

The pad 20 (FIG. 1) is formed of a material that is compatible with the roof surface 11 and intended to provide a buffer between the sack 12 and the surface of the roof 11 to protect the roof membrane M. Accordingly, the pad 20 may be composed of a variety of materials, including for example: roof walk pad material; roof shingle material; rubber; roof paper; plastic; foam; wood; cloth; and geo-textile. Preferably, the pad 20 is formed of a geo-textile material that is known to be compatible with most roof membrane materials. The pad 20 is therefore positioned between the sack 12 and the upper surface of the roof 11 such that the sack 12 does not substantially contact the surface 11. The pad 20 may alternatively be attached to the sack 12, or may form a portion of the sack 12 (see FIG. 4). In such a configuration, the pad portion 13 of the sack 15 forms the primary contact between the planter 10 and the surface of the roof 11. Of course, one of ordinary skill in the art will recognize that a protective pad 20 may not be required for all applications, and that the planter 10 may be configured without the pad 20.

The sack 12 of FIG. 1 is formed by sealing two generally rectangular shaped sheets 22, 24 (FIG. 5) of moisture permeable material together along each of three sides of said sheets, thereby forming a pocket between the sheets 22,24 that is capable of retaining the growth media 16. The sheets 22,24 may be sealed together in a number of ways well understood by one of ordinary skill in the art, including but not limited to sewing, heat sealing, gluing and clamping. The remaining fourth sides of each of the sheets 22, 24 define an opening 26 in the sack 12. The growth media 16 is placed in the sack 12 through the opening 26. The opening 26 is then also sealed shut, which may also be accomplished in a number ways well understood by one of ordinary skill in the art, including, for example, tying, sewing, heat sealing, gluing and clamping.

The sack 12 is formed of a fabric 30 as depicted in FIG. 2. The fabric 30 is constructed of a weave that is capable of retaining the desired growth media 16 while being moisture permeable. The fabric 30 is preferably constructed of nylon material, and even more preferably a knitted high density polyethylene. Of course, the fabric 30 that forms the sack 12 may be of differing configurations and formed of different materials depending on the specific formulation of growth media 16 that will be placed in the sack 12. That is, the smaller the granulation of the desired growth media 16 to be placed in the sack 12, the tighter the weave that is required in the fiber 30. Conversely, the larger the granulation of the desired growth media 16 to be placed in the sack 12, the more relaxed can be the weave in the fiber 30. Moreover, the sack 12 can alternatively be constructed, at least in part, of a non-porous material, such as for example plastic (not shown), if the sack 12 has holes, slits or other such openings in the material that are sized and/or positioned on the sack 12 such that they are capable of retaining the growth media 16 while allowing for the penetration of moisture.

The sack 12 of the present embodiment of the planter 10 as shown in FIGS. 1, 2 and 5, is constructed of two sheets 22,24 of fabric 30 where three sides of each of the sheets are sewn together. Of course, the sack 12 could be constructed in alternate ways. For example, the fabric 30 could be produced in the shape of a tube and thereby only require one end to initially be sealed or sewn together to form the sack 12. In any event, once the sack 12 is formed, the user has a number of options in application of the planter 10 upon a roof surface 11.

The adaptive nature of the present roof planter invention provides a substantial improvement over existing roof planters. For example, the sack 12 may be filled with growth media 16 at any time that is most convenient to the user prior to planting the vegetation 18 in the growth media. It may be desirable to fill the sack 12 with growth media 16 at a manufacturing or processing facility and then transport the filled sack 12 and associated pads 20 to a job site where they will then be positioned on the upper surface of a roof 11. The vegetation 18 may be planted in the growth media 16 prior to, or after, the planter 10 is positioned on the roof 11. Alternatively, the sack 12 may be delivered to a job site empty, and the growth media 16 may be placed in the sack 12 at the site. Again, the vegetation 18 may be planted in the growth media 16 prior to, or after, the planter 10 is positioned on the roof 11. In yet another alternative, both the growth media 16 and the vegetation 18 can be added to the sack 12 after the sack 12 is positioned on the pad 20 on the surface of the roof 11.

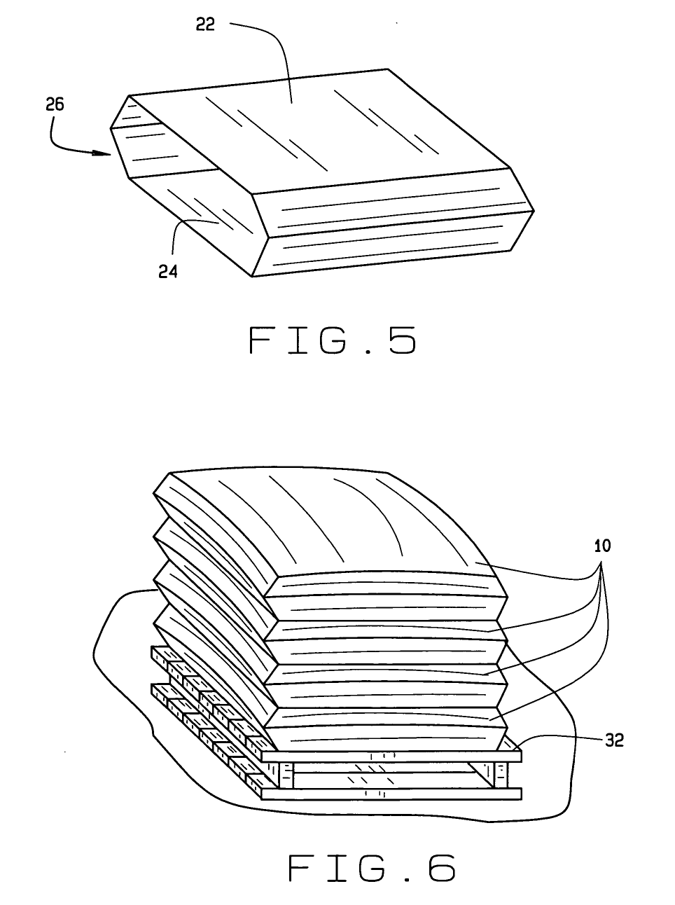

Further, quantities of the sacks 12 can be transported in bulk prior to filling with the growth media 16, or alternatively, quantities of the sacks 12 can readily be transported after already being filled with growth media 16. In the latter case, the sacks 12 may be conveniently stacked in groups or even on a pallet 32 for ease of conventional transport. (see FIG. 6). In this way, the sacks 12 can be readily stacked on pallets in the same manor as soil suppliers currently handle other products. The pre-packed sacks 12 provide an attractive alternate to the cranes and hoisting equipment necessary to hoist dump truck loads of material to the rooftop as pallets of pre-packed sacks 12 can be delivered to loading docks and conveyed to the rooftop using freight elevators. By assimilating into the existing operational infrastructure of the soil suppliers in this manner, little additional set up costs are incurred using the present invention.

In contrast with conventional rigid roof planter systems, which can only be shipped in quantities that cover approximately 64 square feet per standard pallet, the pre-packed sacks 12 can be shipped in quantities that will cover approximately 218 square feet per standard pallet. This increased shipping capacity reduces transport costs at each phase of distribution; warehousing, shipping to the project, and loading to the rooftop. Additionally, this concept allows for pre-packed soil to be easily warehoused and stocked without consideration given to shipping and storage duration or weather conditions. Moreover, the flexible and durable nature of the sacks 12 also allows for convenient transport with a lower likelihood of damage as compared with conventional rigid roof planters.

Hence, the sack 12 may be transported, along with the growth media 16 and the vegetation 18 and the protective pad 20, to a desired job site. There, the sack 12 may be filled with the growth media 16 before or after placement of the sack 12 on the roof surface 11. Similarly, the slits 14 may be formed or cut into the sack 12 before or after placement of the sack 12 on the roof surface 11. In fact, the slits 14 can even be formed in the sack 12 during manufacture of the sack 12 or prior to transport. It then follows that the vegetation 18 may be placed in the growth media 16 prior to placement on the roof surface 11 or after the sack is placed on the roof surface 11, so long as the sack 12 has first been filled with the growth media 16, and the slits 14 have been formed or cut into the sack 12.

As can be appreciated, all these variations and options in formation and placement of the sack planter 10 on a roof surface 11 provide a great degree of flexibility to the installer or user. In addition, the sack planter 10 can be manufactured in nearly limitless variations of size, shape and material configuration. Hence, the shape, size and weight of the planter 10 can readily be altered either at the manufacturing facility or even at the job site to accommodate specific needs or even aesthetic or artistic expression on any given installation.

Further exhibiting the unique adaptive characteristics of the present invention 10, due to its pliant nature and the large contact area of relatively high friction materials, the sack planter 10 is remarkably stable when properly positioned on the roof surface 11. Yet, the roof planter 10 can readily be removed from its resting location to allow, for example, the repositioning of the planter 10, inspection or repair of the planter 10, or inspection or maintenance of the surface of the roof 11. In addition, due to their compliant and formable nature, multiple sacks 12 of the present invention can be positioned next to one another with minimal precision, and yet accomplish proper installation and placement. As a result, the positioning of multiple sacks 12 on the surface of a roof 11 can be accomplished in less time and with less difficulty than is required for the positioning of conventional roof planters. These benefits are in addition to the benefits of the fabric roof planter over conventional roof planters realized due to the ease with which the fabric roof planter can be transported.

As a further feature of the present invention, the roof planter 10 may be placed upon a suitable roof surface 11, where the roof surface 11 is covered at least in part by a surface membrane M of roofing material having a known surface composition. (FIG. 1). Again, the roof surface 11 may be of virtually any profile, including for example, flat, pitched, curved or otherwise uneven. The pad 20 can be constructed from walk pad material specifically chosen to be compatible with the roofing material M upon which the particular roof planter 10 will rest. Generally, a specific roofing material manufacturer will identify specific walk pad materials that can be used upon that manufacturer's roofing material without voiding the manufacturer's warranty. Such walk pads have properties that result in an acceptable level of chemical and physical wear to the manufacturer's roofing material. Typically, each roofing material manufacturer will offer walk pads for use on its own roofing products. In this embodiment, it is preferable that the pad 20 be constructed of a material that is certified, or at least recognized or otherwise approved, by specific roofing material manufacturers to be compatible with specific roofing materials.

For example, should the roof planter 10 be slated for placement atop a roof having Firestone Building Products (“Firestone’) roofing material, then the pad 20 for that specific application would be constructed of walk pad material produced by Firestone, or in the alternative, the pad 20 could be constructed of any other material specifically approved for such use by Firestone. Alternately, the pad 20 may be compatible if they are constructed of a material that imparts minimal chemical degradation or physical wear to the roofing material, even if the pad 20 is not recognized or certified by any roofing material manufacturer. Of course, it is also possible that in certain applications, the sack 12 itself may be compatible with the roof surface membrane M, so that no pad 20 is necessary for such applications.

Additional variations on the basic construction are also available. For example, the exact shape and size of the roof planter 10 can be varied to form larger or smaller roof planter configurations. The sack 12 may be thick or thin. Further, the sack 12 may be shaped in a variety of configurations in all three dimensions, taking for example the shape of a box, a tube, or a cup. Hence, the roof planter 10 may be a shape other than rectangular or square, such as, round, oval, triangular, or any other shape desired by the user. The sack 12 of the roof planter 10 may be constructed of a variety of materials, including but not limited to fabric, woven knitted high density polyethylene, rubber, paper, plastic, foam and cloth, or any other suitable material that is moisture permeable while being capable of retaining the growth media 16. Each dimension of the roof planter 10, and thereby all of its components, may be of varying sizes. Similarly, more than one pad 20 may be used for each sack 12, or more than one sack 12 may be placed on a single pad 20. The exact number of pads 20 used in each embodiment may vary. For instance, in some applications it may only be desirable to use a single pad 20, while in other applications, a larger number of pads 20 may be desirable. In still other applications, it may be desirable to place more than one sack 12 on a single pad 20, or to bridge one or more sacks 12 across one or more pads 20. Further, the pad 20 may be formed of a single layer of material, or may be formed of two or more such layers. Hence, the number of pads 20 used may vary from a single pad to as many as the user may deem appropriate for the specific application. Further, the pads 20 may be attached to either the roof surface 11 or to the sack 12, and this attachment may be accomplished by a number of methods, including for example, the use of adhesives, rivets, bolts, slides, hinges, and nails, as well as other methods that would be readily apparent to one of ordinary skill in the art. Alternately, the pad 20 may be attached to the sack 12 and the sack 12, with the attached pad 20, can then be set upon the roof surface 11. The pad 20 may also be formed in a variety of shapes, such as oval, round, hexagonal or polygonal. The pad 20 may be of uniform or non-uniform dimensions, including thickness. The pad 20 may be perforated, and may comprise surface features such as abrasions, pits, and extrusions.

Of course, one of ordinary skill in the art will recognize that structural members may be added to strategic positions on or in the roof planter 10 to allow the use of a variety of materials. In addition, drain holes may be added to the sack 12 or the pad 20 to regulate the moisture content of the roof planter 10. Such drain holes may be covered with mesh or other covering to help prevent the release of the growth medium 16 from the roof planter 10.

The number and configuration of the slits 14 can also be varied. Virtually any reasonable number of slits 14 may be formed or cut into the sack 12, so long as the vegetation 18 can be planted through the slits 14 and the slits 14 are not so numerous or positioned so that they materially degrade the functional integrity of the sack 12 nor the ability of the sack 12 to retain the growth media 16. In addition, the slits 14 may be formed in virtually any shape and size, such that the slits 14 may actually be openings and not slit-shaped at all, again so long as the vegetation 18 can be planted through the slits 14 (or openings) and the configurations do not materially degrade the functional integrity of the sack 12 nor the ability of the sack 12 to retain the growth media 16.

Further, the roof planter 10 may additionally incorporate features to aid in handling the planter, such as handles and grips. For instance, the sack 12 or the pad 20 may be shaped to incorporate handles, grips or grip holes, or such features may simply be attached to the roof planter 10. In addition, the vegetation 18 may consist of virtually any plant or combination of different plants that may be selected by the user.

The detailed description above illustrates the invention by way of example and not by way of limitation. This description clearly enables one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

1. In combination with a roof having an upper surface, a roof planter comprising:
a. growth media capable of sustaining a desired vegetation; and
b. a sack comprising a moisture permeable material capable of retaining the growth media, the sack being configured to retain a quantity of the growth media, the sack being capable of placement on the upper surface of the roof;
wherein when said quantity of growth media is retained by the sack, and the desired vegetation is planted in the growth media retained by the sack, and the sack is positioned on the upper surface of the roof, the planter provides an adaptable housing for the growth of the vegetation on the roof.

2. The combination of claim 1, wherein the desired vegetation is planted in the growth media after positioning of the sack on the roof.

3. The combination of claim 1, wherein the desired vegetation is planted in the growth media prior to positioning of the sack on the roof.

4. The combination of claim 1, wherein the sack comprises a first opening, the sack being capable of accepting the growth media through the first opening.

5. The combination of claim 4, wherein the sack is sealed after accepting the growth media.

6. The combination of claim 4, wherein the sack comprises a second opening, the second opening being capable of providing access to the growth media for the planting of the desired vegetation in the planter.

7. The combination of claim 6, wherein the opening comprises a slit.

8. The combination of claim 6, wherein the opening is formed in the sack prior to the said quantity of growth media being retained by the sack.

9. The combination of claim 6, wherein the opening is formed in the sack after the said quantity of growth media is retained by the sack.

10. The combination of claim 1, including a pad in association with the sack, the pad being positioned between the sack and the roof, the pad providing a separation between the sack and the roof.

11. The combination of claim 10, wherein the pad comprises a material that is compatible with the upper surface of the roof such that placing the planter on the roof does not materially degrade the integrity of the roof.

12. The combination of claim 10, wherein the pad comprises one or more of the materials selected from the group comprising:
roof walk pad material;
roof shingle material;
rubber;
roof paper;
plastic;
foam;
wood;
cloth; and
geo-textile.

13. The combination of claim 1, wherein the sack comprises one or more of the materials selected from the group comprising:
fabric;
woven knitted high density polyethylene;
rubber;
paper;
plastic;
foam; and
cloth.

14. A method comprising:
a. selecting vegetation for growth on a roof;
b. selecting growth media capable of sustaining the vegetation;
c. creating a sack capable of placement upon a roof, the sack being moisture permeable while also being capable of retaining the growth media;
d. placing a quantity of the growth media in the sack;
e. placing the vegetation in the growth media; and
f. placing the sack on the roof.

15. The method of claim 14, further comprising positioning a pad between the sack and the roof.

16. The method of claim 15, wherein the pad comprises one or more of the materials selected from the group comprising:
roof walk pad material;
roof shingle material;
rubber;
roof paper;
plastic;
foam;
wood;
cloth; and
geo-textile.

17. The method of claim 15, further comprising selecting a pad comprising a material for that is compatible with the surface material of the roof such that placing the sack on the roof does not materially degrade the integrity of the roof.

18. The method of claim 14, further comprising sealing the sack after placing the growth media in the sack.

19. The method of claim 14, further comprising forming a first opening in the sack, the sack thereby being capable of accepting the growth media through the first opening.

20. The method of claim 19, further comprising forming a second opening in the sack, the second opening being capable of providing access to the growth media for the placing of the vegetation in the growth media through the sack.

21. The method of claim 20, wherein the second opening comprises a slit.

22. The method of claim 20, wherein forming the second opening occurs prior to placing the sack on the roof.

23. The method of claim 20, wherein forming the second opening occurs prior to placing growth media in the sack.

24. The method of claim 14, wherein placing the growth media in the sack occurs prior to placing the sack on the roof.

25. The method of claim 14, wherein placing the vegetation in the growth media occurs prior to placing the sack on the roof.

26. An adaptable roof planter comprising:
a. growth media capable of sustaining a desired vegetation;
b. a sack formed of pliant moisture permeable material that is capable of retaining a quantity of the growth media, the sack being capable of positioning on a roof; and
c. a pad capable of separating the sack from the roof;
wherein when said quantity of growth media is retained by the sack, and the desired vegetation is planted in the growth media retained by the sack, and the sack is positioned on the roof, and the pad is positioned between the sack and the roof, the vegetation may grow in the sack on the roof without causing damage to the roof.

27. The roof planter of claim 26, wherein the sack comprises one or more of the materials selected from the group comprising:
fabric;
woven knitted high density polyethylene;
rubber;
paper;
plastic;
foam; and
cloth.

28. The roof planter of claim 26, wherein the pad comprises one or more of the materials selected from the group comprising:
fabric;
woven knitted high density polyethylene;
roof walk pad material;
roof shingle material;
rubber;
roof paper;
plastic;
foam;
wood;
cloth; and
geo-textile.

29. The roof planter of claim 26, wherein the pad is attached to the sack.

30. The roof planter of claim 26, wherein the pad forms a portion of the sack such that the sack is capable of placement on the roof with only the pad contacting the roof.

31. The roof planter of claim 26, wherein the sack has an opening capable of accepting the growth media;

32. The roof planter of claim 31, further comprising a second opening capable of providing access to the growth media for the planting of the desired vegetation in the planter.

33. The roof planter of claim 32, wherein the second opening comprises a slit.

34. The roof planter of claim 32, wherein the second opening comprises a slit.

35. The roof planter of claim 31, wherein the first opening is closable.

36. The roof planter of claim 31, wherein the first opening is closed after the sack accepts the growth media.
